(19) United States
(12) Patent Application Publication
(10) Pub. No.: US 2025/0116510 A1
(43) Pub. Date: Apr. 10, 2025

(54) MEASURING A STATOR SHAFT AND ASSEMBLING A STATOR AND A GENERATOR

(71) Applicant: Siemens Gamesa Renewable Energy A/S, Brande (DK)

(72) Inventors: Marius Fuerst-Sylvester, Cuxhaven (DE); Benjamin Henriksen, Herning (DK); Thorsten Schneider, Bremervörde (DE); Martin Bach Soerensen, Herning (DK)

(21) Appl. No.: 18/730,356

(22) PCT Filed: Mar. 16, 2023
(86) PCT No.: PCT/EP2023/056746

§ 371 Date: Jul. 19, 2024

(30) Foreign Application Priority Data
Mar. 16, 2022 (EP) 22162428.1

(51) Int. Cl. G01B 11/24; G01S 7/481; G01S 17/88; H02K 7/08; H02K 21/22

(52) U.S. Cl. CPC G01B 11/24; G01S 7/4814; G01S 7/4817; G01S 17/88; H02K 7/088; H02K 21/22

(57) ABSTRACT

It is described a method of measuring a geometric characteristic of a stator component (2) of an electrical machine (30), the method comprising: arranging an optical measurement device (5) at a predetermined position (6) relative to the stator component (2), in particular at a first side of the stator component; measuring, by the optical measurement device (5), positions of plural measurement locations (10a, 10b) being in predetermined spatial relations to plural stator component locations (23a, 23b) while keeping the position of the optical measurement device (5) and the stator segment (2) fixed; determining the geometric characteristic based on the measured positions of the plural measurement locations (10a, 10b).

### FIELD OF THE INVENTION

The present invention relates to a method of measuring a geometric characteristic of a stator component of an electrical machine, relates to an arrangement for measuring a geometric characteristic of a stator component of an electrical machine, and relates to a method of assembling a stator of an electrical machine and to a method of assembling an electrical machine.

### ART BACKGROUND

For manufacturing a generator, a stator needs to be assembled and a rotor needs to be mounted together with the stator. The stator may be comprised of several components or portions which need to be mounted to each other. The stator needs to be cylindrically symmetric with respect to a stator axis. The rotor needs to be mounted relative to the stator, such that the rotor symmetry axis coincides with the stator symmetry axis. In case the stator is comprised of several components, the different stator components need to be assembled such that the symmetry axis of one component, for example the stator shaft, coincides or is equivalent to a resulting symmetry axis of the entire stator including the stator segments. For example, when it is required to mount at a stator shaft plural stator segments, those stator segments need to be mounted such that the resulting outer surface of the mounted stator segments adheres to a cylinder symmetry with respect to the symmetry axis of the stator shaft.

Conventionally, measurement of a stator component, in particular a stator shaft, for preparing or even performing a correct assembly of the stator has been observed to be difficult.

Thus, there may be a need for a method of measuring a geometric characteristics of a stator component of an electrical machine, there may be a need of a corresponding arrangement and further there may be a need of a method of assembling a stator of an electrical machine and a method of assembling an electrical machine, wherein the resulting stator to a better degree adheres to design requirements and wherein operation of the electrical machine, when assembled with the rotor, is improved.

### SUMMARY OF THE INVENTION

This need may be met by the subject matter according to the independent claims. Advantageous embodiments of the present invention are described by the dependent claims.

According to an embodiment of the present invention it is provided a method of measuring a geometric characteristic of a stator component of an electrical machine, the method comprising: arranging an optical measurement device at a predetermined position relative to the stator component, in particular at a first side of the stator component; measuring, by the optical measurement device, positions of plural measurement locations being in predetermined spatial relations to plural stator component locations while keeping the position of the optical measurement device fixed; determining the geometric characteristic based on the measured positions of the plural measurement locations.

The geometric characteristic of the stator component may comprise a definition of or information regarding the shape of the stator component, the positioning and/or orientation of one or more portions, in particular connection surfaces of the stator component, a symmetry axis of the stator component or the like.

The electrical machine may for example be a permanent magnet synchronous electrical machine, which may comprise, in an assembled state, the stator component, in particular stator shaft, to which plural stator segments are mounted, wire windings and a rotor with for example permanent magnets. In other embodiments, the electrical machine may be an induction machine.

The optical measurement device may comprise a light source for generating a light beam, in particular laser beam, in the ultraviolet, the visible light region and/or the infrared light region. The optical measurement device may comprise scanning capability, in order to direct a measurement beam, in particular laser beam, to different portions of the stator component. In particular, the optical measurement device may be positioned relative to the stator component such that a viewing range or a scan range of the optical measurement device covers at least regions of interest of the stator component.

During the optical measurements, the optical measurement device does not need to be moved. During the measurements, the optical measurement device may remain at the fixed predetermined position relative to the stator component. In particular, the optical measurement device may be spaced apart in an axial direction of the stator component, preferably satisfying a substantially cylinder symmetry. When the optical measurement device does not need to be moved for performing the measurements, the measurement process may be simplified.

The measurement locations do not need to be particular locations at the stator component, but may be formed by auxiliary members arranged or attached to the stator component. In other embodiments, the measurement locations may coincide or may be the actual stator component locations of interest. In this embodiment, any auxiliary members for performing the measurements may not be required. In any case, the plural measurement locations are in predetermined spatial relations to the plural stator component locations. For example, the measurement locations may be (for example axially) offset from the stator component locations. Thus, measuring the positions of the measurement locations enables to calculate (based on the predetermined spatial relations, in particular the offsets) the positions of the stator component locations. Thereby, the stator component may be measured regarding its geometric characteristic in a reliable manner, via measurement of the measurement locations or via measurement of the positions of the plural measurement locations. The geometric characteristic of the stator component is determined based on the measured positions of the plural measurement locations and in particular further based on the predetermined spatial relations, in particular potential offsets in an axial and/or radial and/or circumferential direction.

According to an embodiment of the present invention, determining the geometric characteristic comprises: determining the geometric characteristic of at least one connection surface of the stator component, the connection surface including the stator component locations.

For assembly of the stator and in general the entire electrical machine, the stator component may be required to be mounted at or assembled with one or more other components. For this mounting or assembling procedure, the geometric characteristic of at least one connection surface may be helpful or required. Thus, determining the geometric characteristic of at least one connection surface of the stator segment may simplify or enable downstream mounting or assembly steps of different components to each other, such that the assembled stator or the assembled electrical machine adheres to design requirements or definitions, thereby prohibiting collisions, in particular prohibiting an uneven air gap between a stator and a rotor, avoiding or reducing an irregular shape, for example deviating from a cylinder shape or a circular shape of the stator connection surfaces, for example.

The method may comprise to first define the plural measurement locations based on previously defined connection surface locations.

According to an embodiment of the present invention, the stator component comprises a first connection surface, in particular first flange surface, and a second connection surface, in particular second flange surface, being spaced apart from the first connection surface in an axial direction, the measuring the plural measurement locations comprising: measuring first plural measurement locations being in predetermined spatial relations to plural first connection surface locations; and measuring second plural measurement locations being in predetermined spatial relations to plural second connection surface locations.

The first connection surface may comprise a substantially flat surface, for example substantially a circular ring. Also the second connection surface may be designed to be a substantially flat surface, in particular a substantially circular ring surface. The first (and/or second) connection surface may be interrupted by plural holes or openings which may be designed to receive bolts for connecting another member to the first connection surface and for connection of still another member to the second connection surface. The first connection surface may have a bigger size, for example bigger diameter, than the second connection surface. The first plural measurement locations may be equal or different to the first connection surface locations. The first connection surface locations may be comprised or included in the first connection surface. The second plural measurement locations may be same or different from the second connection surface locations. The second connection surface locations may be comprised in or included in the second connection surface. The first plural measurement locations may for example be offset, in particular axially offset, from the plural first connection surface locations. Also the second plural measurement locations may be offset, in particular axially offset, from the plural second connection surface locations.

The first and second plural measurement locations may be provided as particular reflection surfaces of auxiliary members as will be explained below.

The measurement locations and in particular the first connection surface locations and/or the second connection surface locations may be defined or selected or determined, in order to reliably obtain the geometric characteristic of the stator component, in particular in order to obtain the geometric characteristic of the first connection surface and/or the second connection surface. Thereby, the method may be simplified and accuracy may be improved.

According to an embodiment of the present invention, determining the geometric characteristic comprises, in particular based on the measured first plural measurement locations and/or measured second plural measurement locations, at least one of: determining at least one geometric characteristic, in particular center point and/or shape and/or position and/or orientation, of the first connection surface and/or the second connection surface; determining an orientation and/position of an axes joining center points of the first connection surface and the second connection surface; determining whether the first connection surface is parallel to the second connection surface.

The first connection surface and/or the second connection surface may each substantially be a planar circular ring. The center point of the respective circular planar rings may be the center of the circle (inner circle or outer circle of the rings). The shape may for example be a substantially circular shape or circular ring shape. The position may be specified in three dimensions, for example x, y, z, or in cylinder coordinates like radial distance from the symmetry axis and axial position and circumferential position. The axes joining the center point of the first connection surface and the second connection surface may substantially be (in the ideal case) equal or coincide with a symmetry axis of the stator component. Determination of the symmetry axis may enable or help to align and mount plural stator segments at the stator which should also then adhere to a cylinder symmetry with respect to the symmetry axis of the stator shaft.

Ideally, the first connection surface may be required to be parallel to the second connection surface. Determination of any potential deviations from the parallel orientation of the first and second connection surface may enable to adapt an assembly method in order to reduce the deviation from the design requirements. For example, spacer element(s) and/or adapter(s) may be inserted, when it is determined that the first and second connection surfaces are not exactly parallel to each other. Bore holes or holes for bolts having wider diameter or space than the bolts may provide some readjustment or shifting possibilities.

According to an embodiment of the present invention, at least of the following holds: the stator component being integrally formed; the stator component substantially having cylinder symmetry; the stator component being a stator shaft at which plural stator segments are to be mounted; the first connection surface substantially being a circular ring; the first connection surface facing a first side of the stator component; the second connection surface substantially being a circular ring; the second connection surface facing a second side of the stator component; the first connection surface is arranged at a first axial end of the stator component; the second connection surface is arranged at a second axial end of the stator component; the first connection surface serves to mount a bearing for rotationally supporting a rotor relative to the stator component, the second connection surface serves to mount the stator component to a nacelle.

The stator component may for example be manufactured from or may comprise steel and/or copper, soft iron plates. The stator component may for example be an integrally formed cast part. Thus, the measurement method may measure the geometric characteristic of a single integrally formed part, namely the stator component. The plural stator segments may be mounted directly or indirectly at the stator shaft, for example utilizing further radially protruding connection members or bars or plates. Thereby, conventionally used or available stator components may be supported regarding determination of the geometric characteristic.

According to an embodiment of the present invention, the optical measurement device is configured as light detection and ranging device (LIDAR).

The light detection and ranging device may also be referred to as laser radar device. The optical measurement device may utilize a laser beam which may be scanned across the components to be measured. Thereby, conventionally available measurement devices are supported or usable for implementing the method.

An advantage of using a Laser radar may include that it is possible to measure the surfaces of the components without any special surface treatments or not requiring shiny surface properties or particular reflection properties of the surfaces to be measured.

According to an embodiment of the present invention, the method comprises: directing a laser beam onto a deflector, in particular mirror; rotating the deflector to plural angle settings such that the deflected laser beam impacts at least on the plural measurement locations; the method comprising, for each angle setting: detecting the laser beam reflected from the respective measurement location in a time resolved manner; determining a distance between the optical measurement device and the respective measurement location based on the detected laser beam; determining the position of the respective measurement location based on the associated distance and angle setting of the deflector.

The laser beam may have wavelengths in the infrared, visible light or ultraviolet region of the spectrum. The laser beam may have a constant wavelength or wavelength range or may be a tuned laser beam which changes wavelengths with time. The optical measurement may enable to determine the positions of the measurement locations, in particular based on a measured distance and an angle setting of the deflector. Thereby, the positions of the measurement locations may be determined in a reliable manner.

According to an embodiment of the present invention, the plural measurement locations are established by reflection surfaces of auxiliary measurement members being arranged at the stator component such that the reflection surfaces are in the predetermined spatial relations to the plural stator component locations.

The auxiliary measurement members may also be referred to as measurement adapters. The auxiliary measurement members may only be needed for performing the measurements but may be removed after the measurements and may not be present in the assembled stator and may not be present in the assembled electrical machine.

The reflection surfaces of the auxiliary measurement members may in particular comprise cat-eye reflectors which may reflect back impinging light in the same direction as or in the opposite direction from the direction of the impact or the direction of the impacting laser beam. Thereby, a laser beam intensity received by a detector of the optical measurement device may be relatively high and in particular much higher than reflected light reflected at other portions of the stator component. Thereby, the measurement may be relatively reliable and accurate regarding the determination of the positions of the measurement locations.

Depending on the particular requirements or application, a number of the auxiliary measurement members may range for example between 10 and 100. The auxiliary measurement members may be placed or positioned and the number of the auxiliary measurement members may be selected such that an accuracy of the determination of the characteristic of the stator component and in particular of the connection surfaces, satisfies predetermined requirements. The auxiliary measurement members may for example be arranged close to or at openings or holes through which bolts are to be guided for mounting one or more other components to the stator component.

According to an embodiment of the present invention, the reflection surfaces of the auxiliary measurement members are arranged at the stator component such that the reflection surfaces are axially offset by a predetermined length relative to the plural stator component locations.

When the reflection surfaces of the auxiliary measurement members are (only) axially offset but may have substantially the same radial and circumferential position as the plural stator component locations, the derivation of the stator component locations based on the measured positions of the reflection surfaces of the auxiliary measurement members may be simplified.

According to an embodiment of the present invention, at least one of the following holds: at least one of the first auxiliary measurement members includes a magnetic member having a reflection surface, in particular facing a first side of the stator component, being attached to the first connection surface by magnet force, at least one of the second auxiliary measurement members includes: an auxiliary member shaft inserted into a bolt hole of the shaft component, a contact surface, in particular facing the first side of the stator component, connected to the auxiliary member shaft and arranged to contact a portion of the second connection surface of the stator component, the second connection surface in particular facing the first side of the stator component, a reflection surface, in particular facing a first side of the stator component.

The magnetic member may be advantageously utilized to attach the first auxiliary measurement member to the first connection surface. Thus, the first auxiliary measurement members may also be easily reversibly removed as needed, when the measurement process is finished.

The second auxiliary measurement members may be inserted through a bolt hole which opens to the second connection surface. The auxiliary member shaft of the second auxiliary measurement member may be designed to closely fit through the hole, in particular bore, according to an H7 fit for example. The contact surface of the second auxiliary measurement member may be spaced apart from the reflection surface of the second auxiliary measurement member by a known distance. Using the known distance between the contact surface and the reflection surface, the position of the second connection surface locations may be derived or calculated using the measured positions of the reflection surface of the second auxiliary measurement member. By utilizing the second auxiliary measurement members, also the geometric characteristic of the second connection surface (in particular facing away from the measurement device or being a backside) may reliably be measured.

It should be understood, that features, individually or in any combination, disclosed, described, explained or provided for a method of measuring a geometric characteristic of a stator component of an electrical machine may also, individually or in any combination, be provided for or applied to an arrangement for measuring a geometric characteristic of a stator component of an electrical machine, according to embodiments of the present invention and vice versa.

According to an embodiment of the present invention it is provided an arrangement for measuring a geometric characteristic of a stator component of an electrical machine, the arrangement comprising: a support system for supporting the stator component in a fixed manner; an optical measurement device arrangeable at a predetermined position relative to the supported stator component, in particular at a first side of the stator component; the optical measurement device being configured: to measure positions of plural measurement locations being in predetermined spatial relations to plural stator component locations while keeping the position of the optical measurement device fixed; to determine the geometric characteristic based on the measured positions of the plural measurement locations.

The support system may hold the stator component in a fixed manner, but may also allow to move the stator component to another orientation or position, when required. During the measurements, the stator component may be in a fixed position. The arrangement may be configured to carry out or control a method of measuring a geometric characteristic of a stator component according to an embodiment of the present invention.

According to an embodiment of the present invention, the optical measurement device comprises at least one of: a laser configured to emit a laser beam; a deflector, in particular including a mirror, rotatable around at least one axis, in particular rotatable around two axes that are perpendicular to each other, the deflector being arranged to deflect the laser beam towards the stator component; a scan drive system to rotate the deflector; a detector to detect a laser beam reflected from the stator component in a time resolved manner; a processor configured to determine a distance between the optical measurement device and the measurement location based on time-of-flight determination and/or frequency shift determination of the reflected laser beam versus the emitted laser beam, the processor being configured to determine a position of the measurement location based on the associated distance and angle setting of the deflector.

The measurement device may be configured as a LIDAR device.

According to an embodiment of the present invention, it is provided a method of assembling a stator of an electric machine, the stator including a shaft and a plurality of stator segments to be coupled to the shaft, the method comprising: performing a method of measuring a geometric characteristic of a stator component of an electrical machine, according to any one of the preceding claims, the stator component being the stator shaft, the geometric characteristic of the stator shaft comprising a geometric characteristic of an axis of the stator shaft; mounting the stator segments at the stator shaft, in particular at mounting members protruding radially outwards, such that an outer surface of the stator segments is substantially cylinder symmetric with respect to the axis of the stator shaft.

Furthermore, a method of assembling an electrical machine is provided which may comprise (first) to assemble a stator and (then) mount a rotor at the stator. In particular, a bearing of the rotor may be mounted at the stator at the first connection surface which had been measured before. The rotor may include plural permanent magnets and the rotor may be configured as an outer rotor. The rotor may be mounted to the stator such that the cylinder symmetry axis of the stator substantially coincides with the cylindrical symmetry axis of the rotor. Eccentricity may be minimized such that an air gap formed between the rotor and the stator may have a substantially even size across the circumferential direction and also the axial direction.

The aspects defined above, and further aspects of the present invention are apparent from the examples of embodiment to be described hereinafter and are explained with reference to the examples of embodiment. The invention will be described in more detail hereinafter with reference to examples of embodiment but to which the invention is not limited.

### BRIEF DESCRIPTION OF THE DRAWINGS

FIG. 1 schematically illustrates an arrangement for measuring a geometric characteristic of a stator component of an electrical machine according to an embodiment of the present invention;

FIG. 2 schematically illustrates a step during assembly of an electrical machine according to an embodiment of the present invention;

FIG. 3 schematically illustrates an auxiliary measurement member according to an embodiment of the present invention which may for example be utilized for the measurement process illustrated in FIG. 1 in a partially inserted state;

FIG. 4 schematically illustrates the auxiliary measurement member illustrated in FIG. 3 in a fully inserted state; and

FIG. 5 schematically illustrates a second auxiliary measurement member attached to a stator component which may be utilized in the method illustrated in FIG. 1.

### DETAILED DESCRIPTION

The illustrations in the drawings are schematic. It is noted that in different figures, similar or identical elements are provided with the same reference signs.

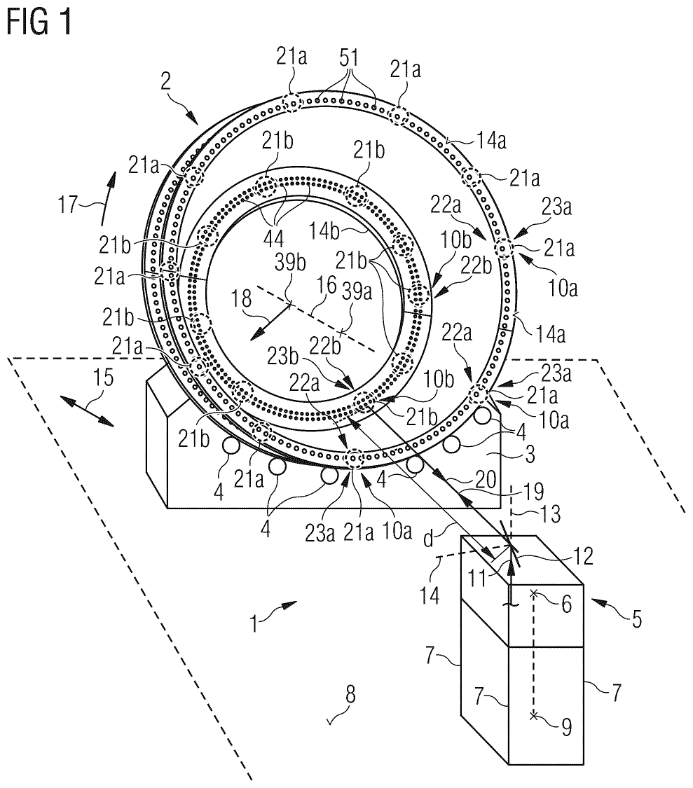

The arrangement 1 for measuring a geometric characteristic of a stator component 2 of an electrical machine illustrated in FIG. 1 comprises a support system 3 for supporting the stator component 2 in a fixed manner. In the illustrated embodiment, the support system 2 may comprise rollers 4 which may enable to rotate the stator component 2 if desired. The stator component 2 is configured as a stator shaft.

The arrangement 1 may be considered to be or comprise a fixed shaft measurement system.

The arrangement 1 further comprises an optical measurement device 5 which is arranged at a predetermined position 6 relative to the supported stator segment 2. In the illustrated embodiment, a measurement device support frame 7 supports the measurement device 5 at a predetermined height above a floor 8. The support frame 7 is positioned at a predetermined position 9 which is marked on the floor 8. The support frame 7 may be in principle movable but may be in a fixed position relative to the stator component 2 during the measurements.

The measurement device 5 is configured to measure plural measurement locations 10a, 10b being in predetermined spatial relations to plural stator component locations 23a, 23b, while keeping the position of the optical measurement device 5 fixed. The measurement device 5 is further configured to determine the geometric characteristic of the stator component 2, in particular stator shaft 2, based on the measured positions of the plural measurement locations 10a, 10b.

The measurement device 5 comprises a not illustrated laser to emit a laser beam 11. The device 5 further comprises a deflector 12 which is rotatable around at least one axis 13, 14, wherein the axis 13 is a vertical axis and the axis 14 is a horizontal axis in the illustrated embodiment. Furthermore, the device comprises a not illustrated scan drive system in order to rotate the deflector 12. Further, the device 5 comprises a detector to detect the laser beam 20 reflected from the stator component in a time resolved manner. A not illustrated processor determines the distance d between the device 5 and the measurement location 10a, 10b based on a time-of-flight determination and/or frequency shift determination of the reflected laser beam vs. the emitted laser beam. Further, the processor is configured to determine a position of the measurement location 10a, 10b based on the associated distance and angle setting of the deflector 12.

Thereby, the arrangement 1 is configured to carry out a method of measuring a geometric characteristic of a stator component of an electrical machine according to an embodiment of the present invention, Thereby, determining the geometric characteristic of the stator component comprises to determine the geometric characteristic of at least one connection surface 14a, 14b. Thereby, the connection surface 14a is a first connection surface, in particular a first flange surface, and the second connection surface 14b is spaced apart from the first connection surface in an axial direction 15 being in the FIG. 1 substantially a horizontal direction and being substantially a symmetry axis of the stator shaft 2.

The connection surfaces 14a, 14b are flange surfaces having holes 51, 44 for inserting bolts for mounting other components.

The method comprises in the embodiment illustrated in FIG. 1 to measure first plural measurement locations 10a which are in a predetermined spatial relation to plural first connection surface locations 23a which are locations at the first connection surface 14a. Further, the method comprises to measure second plural measurement locations 10b which are in predetermined spatial relations to plural second connection surface locations 23b, The second connection surface locations 23b are comprised in the second connection surface 14b which faces away from the view as illustrated in FIG. 1. The first connection surface 14a faces the viewer of FIG. 1. Thus, the first connection surface 14a faces a first side (a front side in FIG. 1) of the stator shaft 2. The second connection surface 14b faces a second side (the back side in FIG. 1) of the stator shaft 2.

Based on the measured first and the measured second plural measurement locations 10a, 10b, the geometric characteristic of the first connection surface 14a and/or the second connection surface 14b may be determined.

In the illustrated embodiment, the stator shaft is integrally formed and has substantially cylinder symmetry with respect to an axis 16. The axis 16 is directed or runs along the axial direction 15. A radial direction 18 is perpendicular to the axial direction 15 and also a circumferential direction 17 is perpendicular to the axial direction 15.

The first connection surface 14a as well as the second connection surface 14b are substantially a cylinder circular ring. The first connection surface 14a is arranged at a first axial end of the stator shaft and the second connection surface 14b is arranged at a second axial end of the stator shaft 2.

At the first connection surface 14a, a bearing may be mounted which is configured to rotatably mount a rotor, in particular an outer rotor during a method of assembling an electrical machine according to an embodiment of the present invention.

At the second connection surface 14b, a nacelle or nacelle frame may be mounted in order to mount the electrical machine to a nacelle of a wind turbine.

The optical device 5 may be configured as a LIDAR device. During the method, the laser beam 11 may be generated and directed to the deflector 12. During the measurement method, the deflector 12 may be rotated to plural angle settings such that the deflected laser beam 19 impacts at least on the plural measurement locations 10b, 10a. For each angle setting, the method may comprise to detect the laser beam 20 which is reflected from the respective location 10b, 10a in a time resolved manner. Further, the method may involve to determine the distance d between the measurement device or in particular the deflector 12 and the measurement location 10b, 10a based on the detected laser beam, in particular based on the reception time of the laser beam relative to the emission time of the laser beam. The laser beam may in particular comprise pulsed laser beam portions which are emitted in a regular manner, for example with a constant time spacing in between.

Based on the determined distance d and the angle setting of the deflector 12, the position of the measurement locations 10b, 10a may be determined. In the illustrated embodiment, the plural measurement locations 10a, 10b are established by reflection surfaces 21a, 21b of auxiliary measurement members 22a, 22b being arranged at the stator component 2 such that the reflection surfaces 21a, 21b are in the predetermined spatial relations to the plural stator component locations. The plural stator component locations are labelled with reference signs 23a, 23b. The reflection surfaces 21a, 21b may be axially offset (i.e. along the axial direction 15 or along the symmetry axis 16) by a predetermined length relative to the plural stator component locations 23a, 23b.

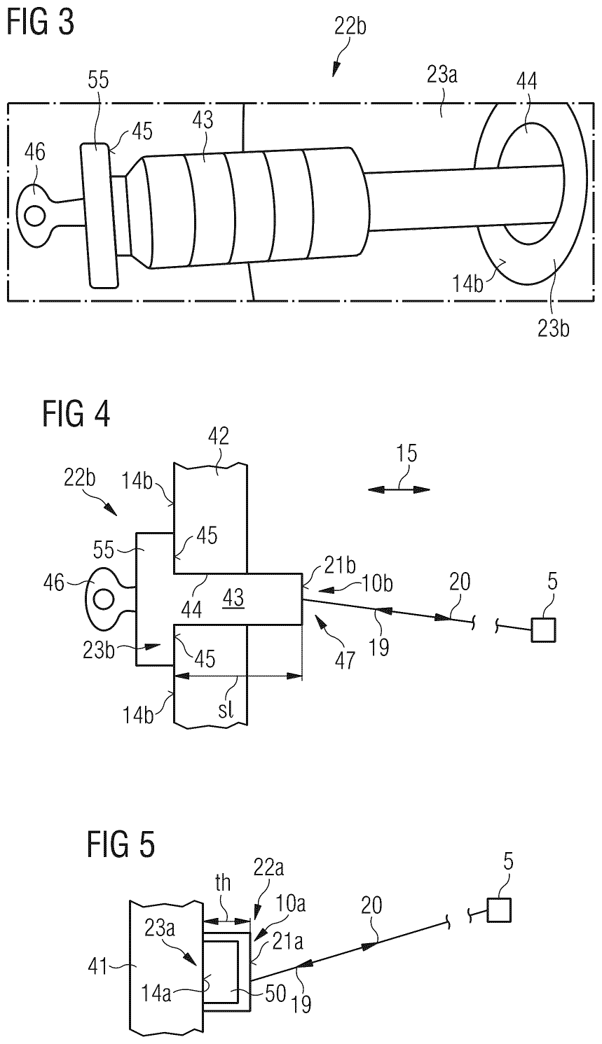

In the illustrated embodiment, first auxiliary measurement members 22a are mounted attached to the first connection surface 14a by magnetic members having the reflection surface 21a. The second auxiliary measurement members 22b will be described with reference to FIGS. 3 and 4 below.

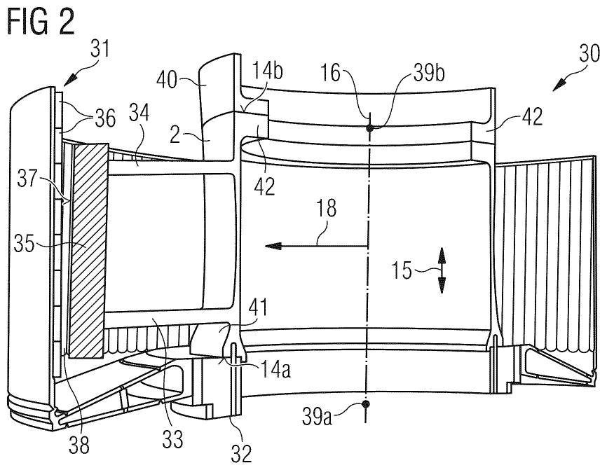

FIG. 2 illustrates in a schematic three-dimensional view a partially broken away view of an electric machine 30 according to an embodiment of the present invention. The electric machine comprises a stator shaft 2 and a rotor 31 which is rotatably mounted at the stator shaft 2 by a bearing 32. In FIG. 2, the first connection surface 14a is at the lower side, i.e. first side of the stator shaft 2 and the second connection surface 14b is at an upper side, i.e. the second side of the stator shaft 2.

Radially protruding (i.e. extending in the radial direction 18) from the stator shaft are two bars or plates 33, 34 to which a respective stator segment 35 is mounted during the method of assembling a stator according to an embodiment of the present invention. The stator component 35 comprises not in detail illustrated teeth and electrical windings. The rotor 31 comprises permanent magnets 36. Between the outer surface 37 of the stator segment 35 and the permanent magnets 36, a gap 38 is formed.

The method may determine the geometric characteristic of the stator shaft 2 in that the (symmetry) axis 16 is determined. In particular, the axis 16 may be determined based on a first center point 39a of the first connection surface 14a and a second center point 39b of the second connection surface 14b. Thus, the axis 16 may be obtained by joining the first and second center points 39a, 39b. The axis 16 may not necessarily correspond to a symmetry axis of the stator shaft 2.

As can be appreciated from FIG. 2, the bearing 32 is mounted at the first connection surface 14b. A nacelle or a frame of a nacelle 40 is mounted at the second connection surface 14b by not illustrated bolts. The first connection surface 14a is a surface of a first flange 41 to which the rotor bearing 32 may be mounted also by not illustrated bolts for example. The second connection surface 14b is a surface of a second flange 42 to which a nacelle frame or nacelle 40 may be mounted.

FIG. 3 illustrates in a schematic three-dimensional view a second auxiliary measurement member 22b according to an embodiment of the present invention which may be utilized for measuring a geometric characteristic of a stator component according to an embodiment of the present invention. The second auxiliary measurement member 22b illustrated in FIG. 3 comprises an auxiliary member shaft 43 which is insertable into a bolt hole 44 of the shaft component. The bolt hole 44 opens to the second connection surface 14b which lies on the back side of the shaft 2 illustrated in FIG. 1. The auxiliary member shaft 43 can be fully inserted into the bolt hole 44, as is illustrated in FIG. 4 in a sectional view.

The second auxiliary measurement member 22b further comprises a contact surface 45 at an end plate 55 which is connected to the auxiliary member shaft 43 and is arranged to contact a portion (stator shaft location 23b) of the second connection surface 14b of the stator component 2. For inserting or removing the second auxiliary measurement member 22b, the member 22b comprises a handle 46 at the plate 55 allowing a maintenance personnel to insert or remove the second auxiliary measurement member 22b from the bolt hole 44.

FIG. 4 illustrates the second auxiliary measurement member 22b in a fully inserted state, wherein the auxiliary member shaft 43 is fully inserted into the bolt hole 44 and wherein the contact surface 45 contacts the second connection surface 14b of the flange 41 at stator shaft location 23b. At the face 47, the second auxiliary measurement member 22b comprises a reflection surface 21b for reflecting the laser beam 19 emitted from the measurement device 5. Upon impacting at the reflection surface 21b, the impinging laser beam 19 is reflected as a reflected beam 20 and is received by the optical measurement device 5 illustrated in FIG. 1. The dimension of the shaft length sl is known so that the position of the second connection surface 14b including a second connection surface location 23b can be determined by measuring the position of the reflection surface 21b.

FIG. 5 illustrates in a cross-sectional view an example of a first auxiliary measurement member 22a as attached to the first connection surface 14a of a flange 41 of the stator shaft 2. The first auxiliary measurement member 22a includes a magnetic member 50 which allows the second auxiliary measurement member 22a to be attached to the first connection surface 14a of the flange 41 of the stator shaft 2. At the attachment region, a second connection surface location 23a is arranged whose position is to be measured. The position of the second location 23a comprised in the first connection surface 14a can be measured by measuring a position of a reflection surface 21a also comprised in the second auxiliary measurement member 22a facing an impinging laser beam 19 such that a reflected beam 20 emanates from the reflection surface 21a of the first auxiliary measurement member 22a. The thickness th of the first auxiliary measurement member 22a is known such that the position of the first connection surface location 23a can be derived from the position of the reflection surface 21a which is measured by the optical measurement device 5.

Embodiments of the present invention allow to assemble a stator of an electrical machine and allow also assembly of an electrical machine. Furthermore, embodiments of the present invention enable to mount the electrical machine at or within a nacelle of a wind turbine.

1. A method of measuring a geometric characteristic of a stator component (2) of an electrical machine (30), the method comprising:
arranging an optical measurement device (5) at a predetermined position (6) relative to the stator component (2), in particular at a first side of the stator component;
measuring, by the optical measurement device (5), positions of plural measurement locations (10a, 10b) being in predetermined spatial relations to plural stator component locations (23a, 23b) while keeping the position of the optical measurement device (5) and the stator segment (2) fixed;
determining the geometric characteristic based on the measured positions of the plural measurement locations (10a, 10b).

2. The method according to the claim 1, wherein determining the geometric characteristic comprises:
determining the geometric characteristic of at least one connection surface (14a, 14b) of the stator component (2), the connection surface including the stator component locations (23a, 23b).

3. The method according to claim 1, the stator component comprising:
a first connection surface (14a), in particular first flange surface, and a second connection surface (14b), in particular second flange surface, being spaced apart from the first connection surface (14a) in an axial direction (15),
the measuring the plural measurement locations comprising:
measuring first plural measurement locations (10a) being in predetermined spatial relations to plural first connection surface locations (23a); and
measuring second plural measurement locations (10b) being in predetermined spatial relations to plural second connection surface locations (23b).

4. The method according to the claim 1, wherein determining the geometric characteristic comprises, in particular based on the measured first plural measurement locations (10a) and/or measured second plural measurement locations (10b), at least one of:
determining at least one geometric characteristic, in particular center point (39a, 39b) and/or shape and/or position and/or orientation, of the first connection surface (14a) and/or the second connection surface (14b);
determining an orientation and/position of an axes (16) joining center points (39a, 39b) of the first connection surface (14a) and the second connection surface (14b);
determining whether the first connection surface (14a) is parallel to the second connection surface (14b).

5. The method according to claim 1, wherein at least of the following holds:
the stator component (2) being integrally formed;
the stator component (2) substantially having cylinder symmetry;
the stator component (2) being a stator shaft at which plural stator segments are to be mounted;
the first connection surface (14a) substantially being a circular ring;
the first connection surface (14a) facing a first side of the stator component;
the second connection surface (14b) substantially being a circular ring;
the second connection surface (14b) facing a second side of the stator component;
the first connection surface (14a) is arranged at a first axial end of the stator component;
the second connection surface (14b) is arranged at a second axial end of the stator component;
the first connection surface (14a) serves to mount a bearing (32) for rotationally supporting a rotor relative to the stator component,
the second connection surface (14b) serves to mount the stator component to a nacelle.

6. The method according to claim 1, wherein the optical measurement device (5) is configured as light detection and ranging device (LIDAR).

7. The method according to claim 1,
the method comprising:
directing a laser beam (11) onto a deflector (12), in particular mirror;
rotating the deflector (12) to plural angle settings such that the deflected laser beam (19) impacts at least on the plural measurement locations (10a, 10b);
the method comprising, for each angle setting:
detecting the laser beam (20) reflected from the respective measurement location in a time resolved manner;
determining a distance (d) between the optical measurement device (5) and the respective measurement location (10a, 10b) based on the detected laser beam;
determining the position of the respective measurement location (10a, 10b) based on the associated distance and angle setting of the deflector.

8. The method according to claim 1, wherein the plural measurement locations (10a, 10b) are established by reflection surfaces (48, 52) of auxiliary measurement members (22a, 22b) being arranged at the stator component (2) such that the reflection surfaces are in the predetermined spatial relations to the plural stator component locations.

9. The method according to claim 1, wherein the reflection surfaces of the auxiliary measurement members (22a, 22b) are arranged at the stator component such that the reflection surfaces (48, 52) are axially offset by a predetermined length relative to the plural stator component locations (23a, 23b).

10. The method according to claim 1, wherein at least one of the following holds:
at least one of the first auxiliary measurement members (22a) includes a magnetic member (50) having a reflection surface (52), in particular facing a first side of the stator component, being attached to the first connection surface (14a) by magnet force,
at least one of the second auxiliary measurement members (22b) includes:
an auxiliary member shaft (43) inserted into a bolt hole (44) of the shaft component (2),
a contact surface (45), in particular facing the first side of the stator component, connected to the auxiliary member shaft (43) and arranged to contact a portion of the second connection surface (14b) of the stator component (2), the second connection surface in particular facing the first side of the stator component,
a reflection surface (48), in particular facing a first side of the stator component.

11. An arrangement (1) for measuring a geometric characteristic of a stator component (2) of an electrical machine (30), the arrangement comprising:
a support system (3) for supporting the stator component (2) in a fixed manner;
an optical measurement device (5) arrangeable at a predetermined position (6) relative to the supported stator component (2), in particular at a first side of the stator component;
the optical measurement device (5) being configured:
to measure positions of plural measurement locations (10a, 10b) being in predetermined spatial relations to plural stator component locations (23a, 23b) while keeping the position of the optical measurement device (5) fixed;
to determine the geometric characteristic based on the measured positions of the plural measurement locations (10a, 10b).

12. The arrangement according to claim 11, wherein the optical measurement device (5) comprises at least one of:
a laser configured to emit a laser beam (19);
a deflector (12), in particular including a mirror, rotatable around at least one axis (13, 14), in particular rotatable around two axes that are perpendicular to each other, the deflector (12) being arranged to deflect the laser beam (11, 19) towards the stator component;
a scan drive system to rotate the deflector;
a detector to detect a laser beam (20) reflected from the stator component in a time resolved manner;
a processor configured to determine a distance (d) between the optical measurement device (5) and the measurement location (10a, 10b) based on time-of-flight determination and/or frequency shift determination of the reflected laser beam versus the emitted laser beam, the processor being configured to determine a position of the measurement location based on the associated distance and angle setting of the deflector.

13. A method of assembling an electric machine, the method comprising:
performing a method of measuring a geometric characteristic of a stator component (2) of an electrical machine, according to claim 1, the stator component is a stator shaft (2), the geometric characteristic of the stator shaft comprising a geometric characteristic of an axis (16) of the stator shaft;
mounting a plurality of stator segments (35) at the stator shaft (2), in particular at mounting members (33, 34) protruding radially outwards, such that an outer surface (37) of the stator segments (35) is substantially cylinder symmetric with respect to the axis (16) of the stator shaft.

14. The method of assembling an electric machine according to claim 1, the method comprising:
mounting a rotor bearing (32) to the stator at the first connection surface (14a) of the stator shaft (2).

15. The method of assembling an electric machine according to claim 1, the method comprising:
mounting the electric machine at the second connection surface (14b) of the stator shaft to a nacelle (40).
